(19) United States
(12) Patent Application Publication
(10) Pub. No.: US 2010/0195309 A1
(43) Pub. Date: Aug. 5, 2010

(54) ILLUMINATED WATERFALL APPARATUS

(75) Inventor: Ryszard Stanislaw Cieslak, Noble Park (AU)

Correspondence Address: WINSTEAD PC, P.O. BOX 50784, DALLAS, TX, 75201, US

(73) Assignee: ASTRAL POOL AUSTRALIA PTY LTD, Noble Park (AU)

(21) Appl. No.: 12/667,264

(22) PCT Filed: Jul. 10, 2008
(86) PCT No.: PCT/AU2008/001015

§ 371 Date: Dec. 30, 2009

(30) Foreign Application Priority Data
Jul. 10, 2007 (AU) 2007903716

(51) Int. Cl. F21V 33/00

(52) U.S. Cl. 362/96

(57) ABSTRACT

An illuminated waterfall apparatus (10) having structure (20, 30) defining an inlet (220) for receiving water, an elongate outlet opening (90) that in situ extends substantially horizontally, a flow path (60) for conveying water from the inlet (220) to the outlet opening (90) from which in operation the water falls in a freely falling stream (200), and a light transmission solid (20) for transmitting light. The light transmission solid (20) is arranged to at least partly define an outer periphery of the flow path (60). The apparatus (10) further includes one or more light sources (50) arranged to project light into the light transmission solid (20) and an optical feature (110) associated with the light transmission solid (20) and being at least approximately parallel to the outlet opening (90) for along the length of the outlet opening (90) deflecting light transmitted by the light transmission solid (20) into the water so that the light is transmitted by the stream of water (200) falling from the outlet opening (90) to produce a decorative effect viewable from in front of the outlet opening (90).

### FIELD OF THE INVENTION

The invention relates to an illuminated waterfall apparatus.

### BACKGROUND OF THE INVENTION

An illuminated stream or body of water is aesthetically pleasing. Illuminated waterfalls, for example, can be of particular decorative value in a swimming pool or spa setting.

Illuminated artificial waterfalls are known. A known configuration includes two closely spaced horizontal plates defining a cavity with an elongate frontal outlet opening from which the water falls. The rear of the cavity is open to define an inlet and is connected to a manifold to which a pump provides a constant supply of water during operation.

A variety of lighting configurations have been implemented to illuminate this form of waterfall. Waterfalls having light sources positioned in the cavity between the plates to illuminate the waterfall from inside the stream of water produce a particularly desirable lighting effect. This arrangement is however problematic as traditional electrical light sources generally require a dry environment such that complex sealing arrangements are required.

Although not well known, one solution that has been implemented includes fibre optic cables extending from a light source into the cavity between the plates to project light directly into the water at locations spaced along the length of the waterfall. This goes some way to solving the problems of sealing the light source, but of course the handling, inserting and sealing of individual optical fibres is also problematic. Moreover, the lighting effect produced by this arrangement has been found to be less than ideal. The intensity of the light is unsatisfactory and each fibre optic cable tends to appear as a discrete source of light. Intense, continuous light across the length of the waterfall is preferred.

A further problem is that in commercially practical embodiments the fibre optic cables are crudely bundled at the light receiving end. As a result, not all of the optical fibres are illuminated which produces a very undesirable irregular distribution of light.

US patent application 2002/0154516 relates to an illuminated waterfall in which light is supplied to the water by an illuminated side lighting probe immersed within the water in the manifold. A transparent insert surrounds the water outlet. The water flowing from the outlet is illuminated by light emanating from the probe and passing through the flowing water and by light emanating from the probe and passing through the transparent portion.

European patent application EP 1023947 describes another approach to producing a decorative illuminated waterfall. The application describes a waterfall having a channel section carrying water to an outlet opening from which the water falls. Light guides in the form of acrylic rods extend in a stream-wise direction from within the channel to follow the side edges of the curved path of the falling water. Inner surfaces of the light guides are roughened to deflect light into the water stream. The acrylic rods are not only unsightly, they are unsuitable for swimming pool applications where it is desirable to have a more “natural” appearance and to avoid physical obstructions to playing in the falling water.

It is not admitted that any of the information in this specification is common general knowledge, or that the person skilled in the art could be reasonably expected to have ascertained, understood, regarded it as relevant or combined it in anyway at the priority date.

It is an object of the invention to provide an improved illuminated waterfall or at least to provide an alternative in the market.

### SUMMARY OF THE INVENTION

There is provided an illuminated waterfall apparatus having:
structure defining an inlet for receiving water, an elongate outlet opening that in situ extends substantially horizontally, a flow path for conveying water from the inlet to the outlet opening from which in operation the water falls in a freely falling stream, and a light transmission solid for transmitting light, the light transmission solid being arranged to at least partly define an outer periphery of the flow path;
one or more light sources arranged to project light into the light transmission solid; and
an optical feature associated with the light transmission solid and being at least approximately parallel to the outlet opening for along the length of the outlet opening deflecting into the water light transmitted by the light transmission solid so that the light is transmitted by the stream of water falling from the outlet opening to produce a decorative effect viewable from in front of the outlet opening.

Advantageously the optical feature may be arranged to deflect light into the flow path so that the light is transmitted by the stream of water falling from the outlet opening to produce a decorative effect viewable from in front of the outlet opening. Preferably the optical feature is at or proximal to the outlet opening. Most preferably the optical feature extends substantially the whole length of the outlet opening.

The light transmission solid may be a plate, which might be substantially horizontal in situ. Preferably the light transmission solid is one of an upper plate and a lower plate which define a portion of the flow path between them. According to preferred embodiments the light transmission solid is the upper plate.

It is desirable to further include a manifold for receiving water from a water supply and distributing water so received along the length of the inlet. The manifold may include a forward wall and a rear wall, each of the forward wall and the rear wall being sealingly connected with a respective one of the upper plate and the lower plate. Preferably the upper plate is sealingly connected to the rear wall and the lower plate is sealingly connected to the forward wall.

An end portion of the light transmission solid may at least partly define the outlet opening.

The optical feature may be a chamfer on the light transmission solid, the chamfer being disposed away from the flow path. Preferably, the chamfer is about 10° to 20° from a surface of the light transmission solid, the surface being disposed away from the flow path. The chamfer may extend for substantially a full thickness of the light transmission solid.

The one or more light sources may be located in a dry area, and may include a plurality of discrete light sources wherein the light transmission solid disperses and merges the light from these discrete light sources so that said decorative effect is substantially uniform. The one or more light sources might be spaced light emitting diodes.

### BRIEF DESCRIPTION OF THE DRAWINGS

FIG. 1 is a front perspective view of a waterfall apparatus according to an embodiment of the present invention, with water falling therefrom;

FIG. 2 is a rear perspective view of the waterfall apparatus of FIG. 1;

FIG. 3 is a cross section view along the line 3-3 in FIG. 2;

FIG. 4 is a fragmentary detailed view indicated by the circle 4 in FIG. 3; and

FIG. 5 is a rear perspective view of selected components of the waterfall apparatus of FIG. 1.

### DETAILED DESCRIPTION OF AN EMBODIMENT

The illuminated waterfall apparatus 10 has four principal components: an upper plate 20 of a light transmissible material (e.g. Perspex), a lower plate 30, a water manifold 40 and a light source in the form of spaced LEDs 50.

As shown, the water manifold 40 is an elongate channel structure defining an elongate chamber 40C. Plates 20, 30 extend horizontally from the open top of manifold 40 and are spaced to define a flow path in the form of a relatively long but thin cavity 60. Plate 20 has a lower surface 120 (FIG. 4) that partly defines an outer periphery of the cavity 60. Cavity 60 extends from the manifold 40 to an outlet opening in the form of horizontal slot-like frontal outlet opening 90 at the free, outer ends of plates 20, 30. In operation a stream 200 of water falls freely from the frontal outlet opening 90.

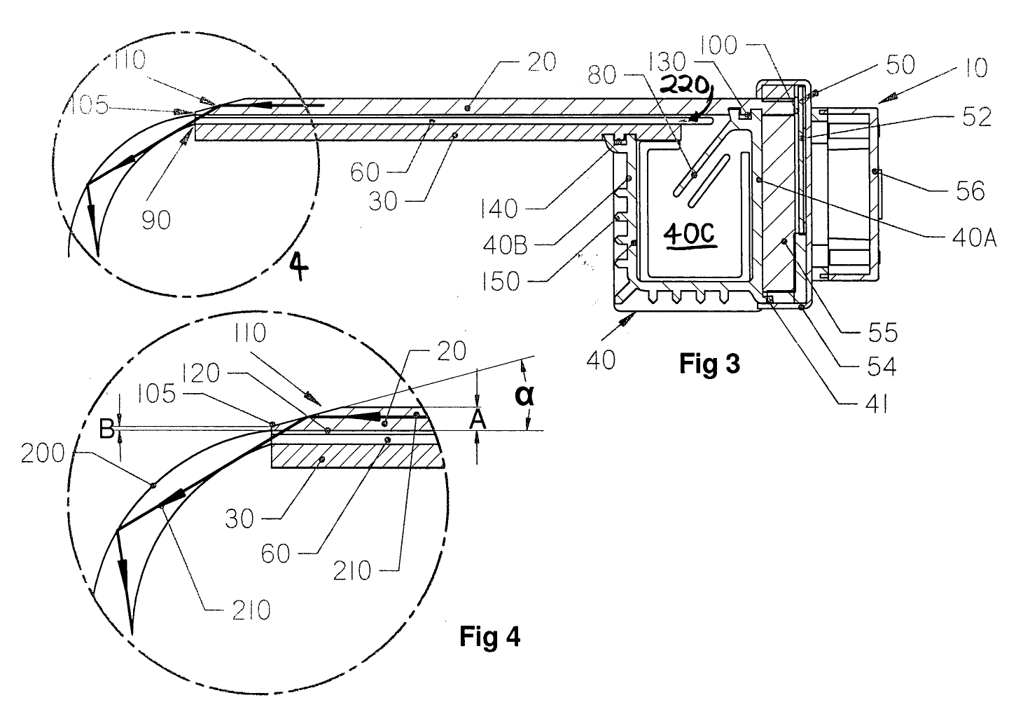

Plates 20,30 are respectively sealingly connected at their rear margins to rear and front manifold walls 40A and 40B at longitudinal seal structures 130,140 such that an inlet 220 (FIG. 3) is defined at the rearward extent of cavity 60 for fluidly connecting cavity 60 to chamber 40C. A plate baffle 80 projects obliquely downwardly from the top edge of rear wall 40A into chamber 40C, and extends substantially the full length of the channel 40C.

The manifold 40 is an extruded component with added end walls 39 sealingly fitted at each end, and longitudinal external ribs 150 that provide rigidity and also key to the concrete during installation, as described below.

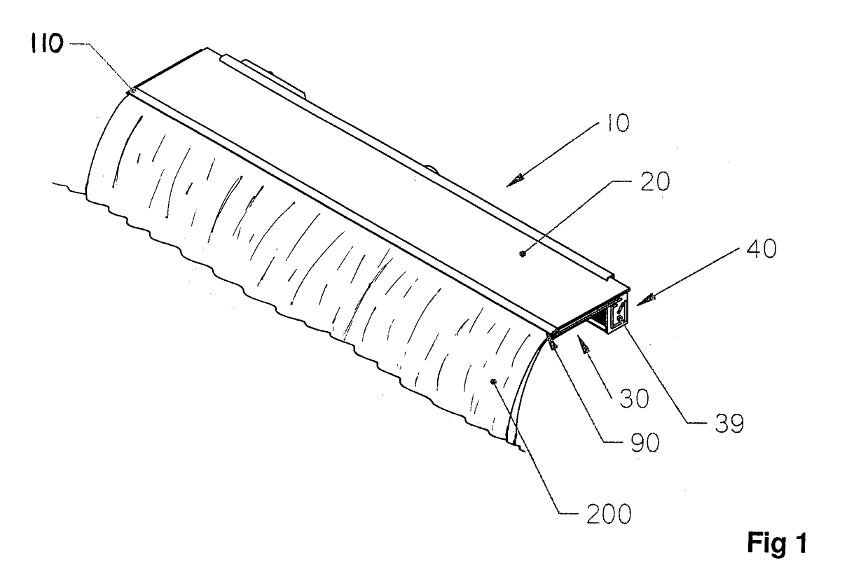

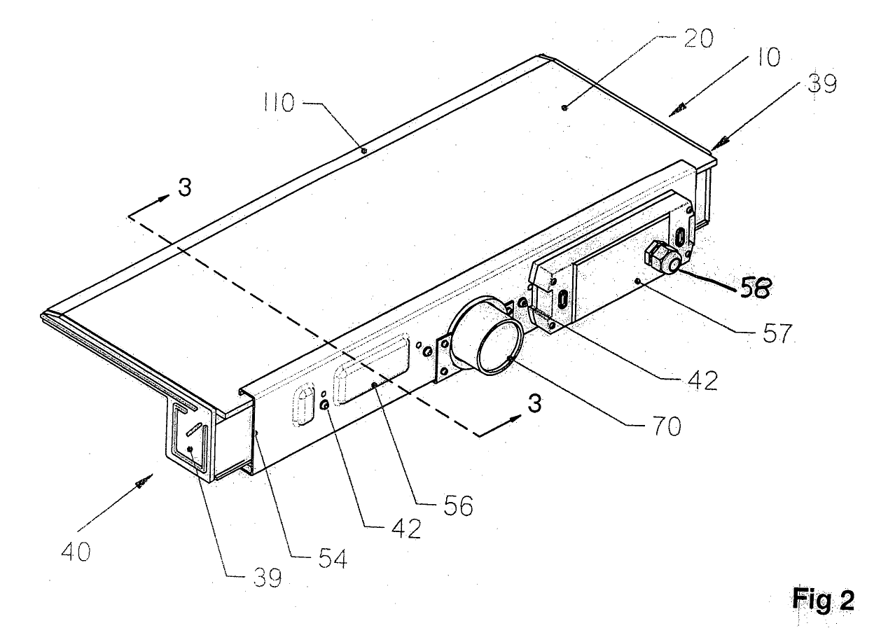

As best seen in FIG. 2, a circular water inlet 70 for admitting water to chamber 40C is rearwardly positioned midway along the length of manifold 40. In use, a pump (not shown) supplies water to chamber 40C of manifold 40 via the inlet 70. The water passes around baffle 80, along the flow path defined by cavity 60 and emerges and falls as a freely falling stream 200 from frontal outlet opening 90 as illustrated in FIG. 1. The long and wide but narrow cavity 60 in combination with baffle 80 ‘smooths’ and evenly spreads the water flow along the full length of frontal outlet opening 90 to produce a desirable uniform curtain like stream of falling water 200.

Illuminated waterfall apparatus 10 is intended to be cemented in place at the edge of a pool (not shown) so that it is hidden from view but for frontal outlet opening 90, which is positioned to project the stream of falling water 200 to splash into the pool. The pump is arranged to draw water from the pool such that the water is continually recycled.

As illustrated in FIG. 3 the rear edge 100 of the plate 20 projects rearwardly beyond the seal structure 130 into a dry area outside of the ‘wet areas’—chamber 40C and cavity 60. The rear edge 100 is thus presented to receive light from the LEDs 50 which are arranged in this dry area without specialised sealing arrangements about the LEDs 50.

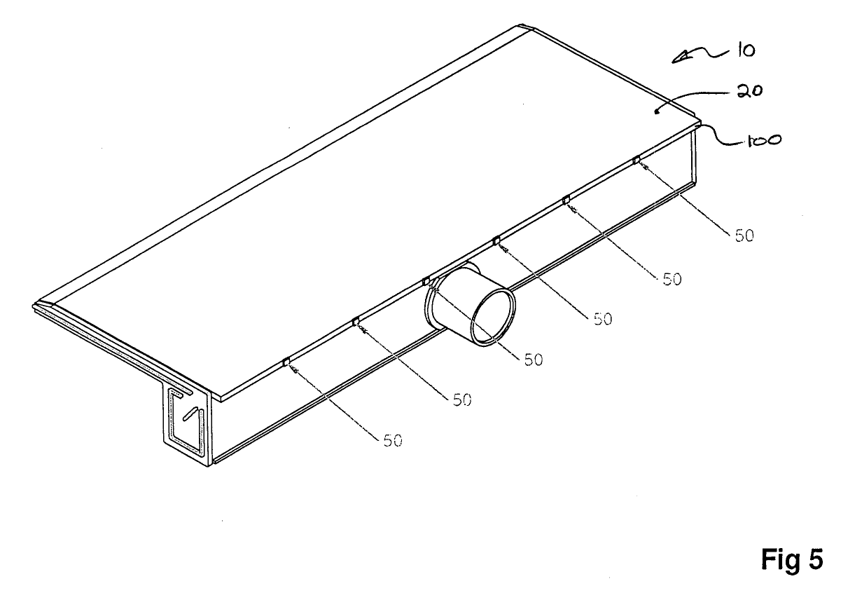

The LEDs 50 are spaced along the rear edge 100 of the upper plate 20 and arranged to project light into the plate 20. FIG. 5 illustrates a fragmentary rear perspective view of the illuminated waterfall apparatus 10. A cover 54 and printed circuit boards (PCBs) 52 (described below) are omitted from FIG. 5 to more clearly show the LEDs 50. The light is transmitted through the plate 20 towards forward edge 105 (FIG. 3) in part by total internal reflection. Plate 50 is of a material selected to diffuse the light in a direction along the length of the plate so that the light from the multiple LEDs 50 is merged into a beam which is substantially uniform along the plate. In this embodiment the plate is of translucent acrylic.

The LEDs 50 are mounted on the printed circuit boards 52, which are in turn clamped in place against the rear edge 100 of plate 20 (with LEDs 50 at edge 100), by an outer, generally U-shaped cover 54. Cover 54 fits about plate 20 and a lower lip 41 (FIG. 3) of manifold 40 and is secured to the latter by screws 42 (FIG. 2), to bound a spacer 55, PCBs 52 and other electronics components (not shown). Access to PCBs 52 and other electronics is via removable sub-closure 57 overlying openings in cover 54.

The cover 54 in this embodiment is formed of pressed metal and includes an indented portion 56 projecting rearwardly to define an enlarged internal region for some of the bulkier electronic components (not shown). Other than the indented portion 56 the cover 54 has a substantially constant cross-section along its length. Seal structure 130 and other seals (not shown) internally mounted within end portions of the cover 54 protect the electronics from ingress of water and debris.

In this embodiment the removable sub-closure 57 is an injection moulded plastic component and is attachable to the cover 54 by screws. The sub-closure 57 serves to house the main power electronics (not shown) and as illustrated includes a gland 58 for sealingly receiving the main power supply lead (not shown).

The forward edge 105 of upper plate 20 is formed with an optical feature in the form of a chamfer 110 at an angle suitable to internally reflect light from the LEDs downward at a sufficiently steep angle to pass through the lower surface 120 (FIG. 4) of plate 20, which defines the upper bound of the cavity 60, and into the water stream. The emerging water stream is depicted at 200 in FIG. 4, while the light trajectory into the water stream is indicated by representative ray lines 210.

A chamfer angle α of about 15° from horizontal, say between 10° and 20°, for chamfer 110 is particularly effective in reflecting light into the water stream. In this embodiment the chamfer 110 extends substantially the full thickness A of plate 20 which in this embodiment is about 6 mm. A small dimension B, about 1 mm in this embodiment, is left so that the material has some strength for handling purposes. The surface of chamfer 110 is polished.

The described illuminated waterfall 10 produces a decorative effect viewable from in front of the outlet opening 90. It has been observed that the falling water stream 200 and a turbulent region where the water splashes into the swimming pool (not shown) are both illuminated. It is believed that light is transmitted in the water stream 200 by a mix of scattering and total internal reflection to the turbulent region, and that the observable illumination of the falling water stream 200 is associated with turbulence at the surface of the falling water stream.

This appearance of light being transmitted by the falling water is an improvement over prior art devices that merely project light toward the falling water from the adjacent outlet.

The electronics (not shown) housed within the cover 54 and sub-closure 57 serve to control the LEDs and the pump. In this embodiment Red-Green-Blue (RGB) LEDs are used such that an almost infinite range of colours can be produced. Other features may include remote controls, lighting pattern animations, and synchronisation of the lighting to music.

Although preferred forms of the invention are described of course other variants are possible. The scope of the invention is to be determined with reference to the claims. For example, a simple form of the invention may include a flow path defined by a horizontal open topped channel, wherein a simple open end of the channel forms the outlet opening and the floor of the channel forms the light transmission solid.

1. An illuminated waterfall apparatus having:
structure defining an inlet for receiving water, an elongate outlet opening that in situ extends substantially horizontally, and a flow path for conveying water from the inlet to the outlet opening from which in operation the water falls in a freely falling stream; the structure including a light transmission solid for transmitting light, the light transmission solid being arranged to at least partly define an outer periphery of the flow path;
one or more light sources arranged to project light into the light transmission solid; and
an optical feature associated with the light transmission solid and being at least approximately parallel to the outlet opening for along the length of the outlet opening deflecting into the water light transmitted by the light transmission solid so that the light is transmitted by the stream of water falling from the outlet opening to produce a decorative effect viewable from in front of the outlet opening.

2. The illuminated waterfall apparatus of claim 1 wherein the optical feature is arranged to deflect light into the flow path so that the light is transmitted by the stream of water falling from the outlet opening to produce a decorative effect viewable from in front of the outlet opening.

3. The illuminated waterfall apparatus of claim 1 wherein the optical feature is at or proximal to the outlet opening.

4. The illuminated waterfall apparatus of claim 1 wherein the optical feature extends substantially the whole length of the outlet opening.

5. The illuminated waterfall apparatus of claim 1 wherein the light transmission solid is a plate.

6. The illuminated waterfall apparatus of claim 5 wherein the light transmission solid is substantially horizontal in situ.

7. The illuminated waterfall apparatus of claim 5 wherein the light transmission solid is one of an upper plate and a lower plate which define a portion of the flow path between them.

8. The illuminated waterfall apparatus of claim 7 wherein the light transmission solid is the upper plate.

9. The illuminated waterfall apparatus of claim 1 wherein the inlet has a length and the illuminated waterfall apparatus further includes a manifold for receiving water from a water supply and distributing water so received along the length of the inlet.

10. The illuminated waterfall apparatus of claim 8 wherein the inlet has a length and the illuminated waterfall apparatus further includes a manifold for receiving water from a water supply and distributing water so received along the length of the inlet, the manifold including a forward wall and a rear wall, each of the forward wall and the rear wall being sealingly connected with a respective one of the upper plate and the lower plate.

11. The illuminated waterfall apparatus of claim 10 wherein the upper plate is sealingly connected to the rear wall and the lower plate is sealingly connected to the forward wall.

12. The illuminated waterfall apparatus of claim 1 wherein an end portion of the light transmission solid at least partly defines the outlet opening.

13. The illuminated waterfall apparatus of claim 1 wherein the optical feature is a chamfer on the light transmission solid, the chamfer being disposed away from the flow path.

14. The illuminated waterfall apparatus of claim 13 wherein the chamfer is about 10° to 20° from a surface of the light transmission solid, the surface being disposed away from the flow path.

15. The illuminated waterfall apparatus of claim 13 wherein the chamfer extends for substantially a full thickness of the light transmission solid.

16. The illuminated waterfall apparatus of claim 1 wherein the one or more light sources are located in a dry area.

17. The illuminated waterfall apparatus of claim 1 wherein the one or more light sources includes a plurality of discrete light sources and the light transmission solid disperses and merges the light from these discrete light sources so that said decorative effect is substantially uniform.

18. The illuminated waterfall apparatus of claim 17 wherein the one or more light sources are spaced light emitting diodes.

19. The illuminated waterfall apparatus of claim 3 wherein the light transmission solid is a plate.

20. The illuminated waterfall apparatus of claim 19 wherein the optical feature is a chamfer on the light transmission solid, the chamfer being disposed away from the flow path.
